(19) United States
(12) Patent Application Publication
(10) Pub. No.: US 2026/0084459 A1
(43) Pub. Date: Mar. 26, 2026

(54) PENCIL FEEDING MECHANISM AND PENCIL SHARPENER PROVIDED WITH PENCIL FEEDING MECHANISM

(71) Applicant: DELI GROUP CO. LTD, Ningbo, Zhejiang (CN)

(72) Inventor: Chengjun PAN, Ningbo, Zhejiang (CN)

(73) Assignee: DELI GROUP CO. LTD, Ningbo, Zhejiang (CN)

(21) Appl. No.: 19/111,116

(22) PCT Filed: Dec. 7, 2023
(86) PCT No.: PCT/CN2023/137143

§ 371 Date: Mar. 12, 2025

(30) Foreign Application Priority Data
Oct. 27, 2022 (CN) 202211328421.8
Jul. 21, 2023 (CN) 202310898711.4

(51) Int. Cl. B43L 23/00

(52) U.S. Cl. CPC B43L 23/002

(57) ABSTRACT

A pencil feeding mechanism and a pencil sharpener provided with the pencil feeding mechanism are provided. The pencil feeding mechanism includes a driving apparatus and a pencil clamping apparatus, where the driving apparatus is connected to the pencil clamping apparatus, and the driving apparatus is capable of driving the pencil clamping apparatus to work. The pencil clamping apparatus includes a support, three pencil clamping roller assemblies are disposed on the support, and a triangular pencil clamping region capable of being inserted by a pencil is formed among the three pencil clamping roller assemblies. One end of each of the pencil clamping roller assemblies is rotatably connected to the support, and the other end of the each of the pencil clamping roller assemblies is slidably connected to the support. A clamping assembly is disposed between a movable end of the each pencil clamping roller assembly and the support.

### CROSS-REFERENCE TO RELATED APPLICATIONS

This disclosure claims priority to Chinese Patent Application No. 202310898711.4, filed on Jul. 21, 2023 and entitled “PENCIL FEEDING MECHANISM AND PENCIL SHARPENER PROVIDED WITH PENCIL FEEDING MECHANISM”, and to Chinese Patent Application No. 202211328421.8, filed on Oct. 27, 2022 and entitled “PENCIL FEEDING MECHANISM AND PENCIL SHARPENER PROVIDED WITH PENCIL FEEDING MECHANISM”.

### TECHNICAL FIELD

This disclosure relates to the technical field of stationery supplies, and in particular, to a pencil feeding mechanism and a pencil sharpener provided with the pencil feeding mechanism.

### BACKGROUND

Pencil sharpeners, as pencil sharpening tools, are very popular among students. The pencil sharpener includes a pencil feeding mechanism and a pencil sharpening mechanism. When a pencil is sharpened, the pencil penetrates the pencil feeding mechanism and enters the pencil sharpening mechanism. After the pencil is fed in place, the pencil is clamped by the pencil feeding mechanism, and then the pencil sharpening mechanism sharpens a head of the pencil. After the pencil is sharpened, the pencil feeding mechanism can also remove the pencil from the pencil sharpener.

The invention patent with a patent announcement number CN215474153U discloses a three-wheel pencil feeding apparatus for a pencil sharpener. The pencil feeding apparatus includes a support, a rotating platform movably installed on the support, and a clamping wheel assembly. A middle of the rotating platform is provided with a pencil feeding hole which a pencil bar penetrates. There are three groups of clamping wheel assemblies, and the three groups of clamping wheel assemblies are disposed in an equilateral triangle with a pencil feeding hole as a center. The pencil sharpener performs sharpening under an even stress and with good stability, so that breaking of a pencil lead can be effectively reduced. In addition, a rubber wheel is seldom worn and slips normally, extending service life of the product. However, the clamping wheel assemblies for such pencil feeding apparatus are fastened and cannot be used in pencils with different shapes and diameters, so that the pencil feeding apparatus is not universally used.

### SUMMARY

In some embodiments, a pencil feeding mechanism is provided, and the pencil feeding mechanism is used in pencils with different shapes and different diameters, so that the pencil feeding mechanism is universally used.

Technical solutions provided in this disclosure are as follows: a pencil feeding mechanism with the following structure is provided, including a driving apparatus and a pencil clamping apparatus. The driving apparatus is connected to the pencil clamping apparatus, and the driving apparatus is capable of driving the pencil clamping apparatus to work. The pencil clamping apparatus includes a support, three pencil clamping roller assemblies are disposed on the support, and a triangular pencil clamping region capable of being inserted by a pencil is formed among the three pencil clamping roller assemblies. One end of each of the pencil clamping roller assemblies is rotatably connected to the support, and the other end of the each of the pencil clamping roller assemblies is slidably connected to the support. A clamping assembly is disposed between a movable end of the pencil clamping roller assemblies and the support. The clamping assembly includes clamping pieces and a return elastic piece. The clamping pieces are movably connected to the support, each of the clamping pieces abuts against the movable end of a corresponding pencil clamping roller assembly in the three pencil clamping roller assemblies, and the return elastic piece is supported between the clamping pieces and the support.

After the foregoing structure is used, compared with existing technologies, the pencil feeding mechanism in this disclosure has the following advantages:

Because one end of the pencil clamping roller assembly of the pencil feeding mechanism in this disclosure is rotatably connected to the support, the other end of the pencil clamping roller assembly is slidably connected to the support. When pencils with different shapes and different sizes are inserted into the triangular pencil clamping region, a position of the other end of the pencil clamping roller assembly is adjusted. The clamping assembly is disposed between the movable end of the pencil clamping roller assembly and the support. The clamping piece is movably connected to the support, the each clamping piece abuts against the movable end of the pencil clamping roller assembly, and the return elastic piece is supported between the each clamping piece and the support. When the other end of the pencil clamping roller assembly moves outward, the each clamping piece provides an elastic thrust to the other end of the pencil clamping roller assembly, so that the pencil clamping roller assembly always contacts the pencil.

As an improvement, the return elastic piece includes an elastic hoop, and the elastic hoop is sleeved outside the other ends of the three clamping pieces. The support is rotatably connected to a synchronizing piece. One end of the elastic hoop is connected to the support, and the other end of the elastic hoop is connected to the synchronizing piece. When the elastic hoop is squeezed by the each of the clamping pieces to be twisted, the synchronizing piece is driven to rotate. After this structure is used, the elastic hoop hoops outside the other end of the clamping pieces, so that the clamping pieces move synchronously, and the pencil clamping roller assembly does not move eccentrically.

As an improvement, the synchronizing piece is disposed on an upper side of the each clamping piece, and a sliding rail is disposed at a position at which the synchronizing piece is corresponding to the clamping piece. A lower end of the each clamping piece is hinged on the support, and an upper end of the each clamping piece is slidably fitted in the sliding rail. The synchronizing piece rotates, to drive the clamping piece to rotate, and the upper end of the clamping piece slides along the sliding rail. After this structure is used, when pencils with different shapes and sizes are inserted into the triangular pencil clamping region, the movable end of the pencil clamping roller assembly is squeezed to move, thus pushing the each clamping piece to rotate. The elastic hoop is twisted when applied with a force, to drive the synchronizing piece to rotate. The synchronizing piece rotates, to drive the upper end of the each clamping piece to slide along the sliding rail, so that the upper end of the each clamping piece makes opening and closing actions with the lower end as a center of a circle. Therefore, a pencil is always in the middle of the three pencil clamping roller assemblies when sharpened, and sharpening is more stable and not eccentric.

As an improvement, a sliding direction of the sliding rail intersects with a swinging direction of the corresponding clamping piece. After this structure is used, when the synchronizing piece is rotated, rotation of the clamping piece is not affected, providing a good cooperation effect.

As an improvement, the support includes an upper cover, and the upper cover is connected on a side that is of the support and that is close to the synchronizing piece; the synchronizing piece is rotatably connected on an upper side of the upper cover; and the elastic hoop is disposed between the upper cover and the synchronizing piece, and an end of the elastic hoop is connected to the upper cover. After this structure is used, the upper cover is disposed to protect an internal structure, so that the structure is more reliable.

As an improvement, a first pencil inserting hole is disposed in the upper cover and above the triangular pencil clamping region, and an orthographic projection of the first pencil inserting hole covers a part of a roller of the each pencil clamping roller assembly; and the upper cover is provided with a matching hole, and the other end of the each clamping piece penetrates the matching hole and is fitted in the corresponding sliding rail. After this structure is used, the structure is simple and reliable, and assembly is easy to perform.

As an improvement, multiple positioning columns are disposed on a side that is of the upper cover and that is close to the synchronizing piece; the synchronizing piece is provided with rotating rail holes that match the positioning columns, and ends of the positioning columns are fitted in the rotating rail holes; and when the synchronizing piece is driven by the elastic hoop to rotate, the positioning columns and the rotating rail holes slide relative to each other. After this structure is used, the positioning column can define a moving track of the synchronizing piece, so that the synchronizing piece can accurately drive the clamping pieces, and an effect of synchronous rotation of the clamping pieces is achieved.

As an improvement, a middle of the synchronizing piece is provided with a fourth pencil inserting hole, and the fourth pencil inserting hole is aligned with the first pencil inserting hole; and the synchronizing piece is provided with an inserting hole, an end of the elastic hoop is folded upward to form an inserting pin, and the inserting pin is inserted into the inserting hole. After this structure is used, the pencil is well positioned, and the elastic hoop and the synchronizing piece are easy to assemble.

As an improvement, a bolt-shaped column is disposed on a side that is of the upper cover and that is close to the synchronizing piece, an end of the elastic hoop is provided with a ferrule, and the ferrule is sleeved outside the bolt-shaped column. After this structure is used, an assembly structure between the upper cover and the elastic hoop is simple, and assembly is easy to perform.

As an improvement, a first support wall and a second support wall are disposed on the support, and the pencil clamping roller assemblies are disposed between the first support wall and the second support wall; each of the pencil clamping roller assemblies includes a rotating shaft, and an end of the rotating shaft is rotatably connected to the first support wall; and the second support wall is provided with a sliding groove, and the other end of the rotating shaft is slidably fitted in the sliding groove. After this structure is used, an assembly structure for the pencil clamping roller assembly is simple, and assembly is easy to perform.

As an improvement, the second support wall is provided with an accommodating cavity, and the accommodating cavity communicates with the sliding groove; and a corresponding clamping piece in the clamping pieces is movably installed in the accommodating cavity, one side of the corresponding clamping piece abuts against a movable end of the rotating shaft, and when the other end of the rotating shaft slides, the corresponding clamping piece can be pushed to move outward. After this structure is used, an assembly structure for the clamping piece is simple, assembly is easy to perform, and the accommodating cavity can limit a movement range for the clamping piece, so that the clamping piece is moved more stably.

As an improvement, an end of the clamping piece is hinged on a side wall of the accommodating cavity, a side of a middle of the clamping piece abuts against the other end of the rotating shaft, and the other end of the clamping piece is connected to the return elastic piece. After this structure is used, a middle of the clamping piece abuts against the other end of the rotating shaft, so that a contact area between the clamping piece and the rotating shaft is large, providing a clamping effect.

As an improvement, a side of the middle of the each of the clamping pieces is an arc-shaped surface, and the arc-shaped surface abuts against the other end of the rotating shaft. After this structure is used, the arc-shaped surface of the clamping piece contacts the other end of the rotating shaft, and a clamping force of the clamping piece can be effectively controlled by setting a radian of the arc-shaped surface, so that a clamping effect is good.

As an improvement, the each of the pencil clamping roller assemblies includes a roller, wherein the roller is installed on the rotating shaft, and a gear is also installed on the rotating shaft; and the gear is connected to the driving apparatus, the driving apparatus is able to drive the gear to rotate, and the gear is capable of driving the rotating shaft and the roller to rotate synchronously. After this structure is used, the rotating shaft and the roller are driven by a gear to rotate, and the structure is simple, providing a good driving effect.

As an improvement, a third support wall is disposed on the support and between the first support wall and the second support wall, and the third support wall is supported on a lower side of a part that is of the rotating shaft and that is between the gear and the roller. After this structure is used, under an action of the third support wall, the rotating shaft is installed more stably.

As an improvement, an upper surface of the third support wall is provided with a first groove, and the rotating shaft is embedded in the first groove. After this structure is used, the rotating shaft is installed reliably.

As an improvement, a side of the gear is connected to a shaft sleeve, a middle of the gear is provided with a shaft hole, and the shaft hole and a through hole of the shaft sleeve are coaxial and communicate; at least one limiting plane is disposed on a side wall of the rotating shaft, and a shape of the shaft hole of the gear and a shape of the through hole of the shaft sleeve match a cross section of the rotating shaft; and the gear and the shaft sleeve are installed outside the rotating shaft as a set, and an end of the shaft sleeve abuts against the roller; and the shaft sleeve is embedded in the first groove. After this structure is used, the structure is simple, and assembly is easy to perform.

As an improvement, a middle of the roller is provided with an installation hole, and a connecting sleeve is disposed in the installation hole; a shape of a through hole of the connecting sleeve matches a shape of the cross section of the rotating shaft, the connecting sleeve is tightly fitted outside the rotating shaft, and the connecting sleeve abuts against an outer side of the shaft sleeve. After this structure is used, an assembly structure of the roller is simple, and assembly is easy to perform.

As an improvement, a limiting sheet is disposed on the rotating shaft and on an outer side of the gear, and the limiting sheet performs limitation on the outer side of the gear. After this structure is used, the limiting sheet plays a role in limiting the gear.

As an improvement, a ball head is disposed at an end that is of the rotating shaft and that is close to the gear, a side wall of the first support wall is provided with an embedding groove that matches the ball head, and the ball head is rotatably connected in the embedding groove. After this structure is used, the ball head is disposed at the end of the rotating shaft, and the ball head cooperates with the embedding groove, so that movement is flexible.

As an improvement, a protruding column is disposed at an end that is of the rotating shaft and that is close to the roller, a cross section of the protruding column is circular, and the protruding column is installed at a groove bottom of the sliding groove in a rolling way. After this structure is used, the protruding column can flexibly move at the groove bottom of the sliding groove.

As an improvement, a limiting ring configured to insert a pencil is disposed in the middle of the support, the limiting ring is connected to both the second support wall and the third support wall, the limiting ring is erected right above the triangular pencil clamping region, and an orthographic projection of the limiting ring covers a part of the roller. After this structure is used, a pencil can be positioned by using the limiting ring, so that the pencil is sharpened more stably.

As an improvement, the driving apparatus includes a base, and a driving member, a transmission assembly, and a teeth plate are disposed in the base; the driving member is configured to be connected to a driving source, the transmission assembly is connected between the driving member and the teeth plate, and multiple stirring teeth are disposed on the teeth plate; and the driving member is capable of driving, by using the transmission assembly, the teeth plate to rotate, and when the teeth plate rotates, the multiple stirring teeth can stir the gear of the each pencil clamping roller assembly to rotate, thereby driving the roller of the each pencil clamping roller assembly to rotate. After this structure is used, a structure of the driving apparatus is simple, assembly is easy to perform, the stirring teeth on the teeth plate stir the gear to rotate, so that a driving manner and structure a simple, and a driving effect is good.

As an improvement, a middle of the base is provided with a partition, the partition divides an inner cavity of the base into a first cavity and a second cavity, and a middle of the partition is provided with a connecting hole; the transmission assembly includes a first driving gear, a middle of the first driving gear is rotatably connected in the connecting hole, a gear part is disposed at an end of the first driving gear, and the gear part extends into the first cavity, the teeth plate is accommodated in the first cavity, and the gear part is in transmission connection with the teeth plate; and a connecting part is disposed at the other end of the first driving gear, and the connecting part extends into the second cavity, the driving member is accommodated in the second cavity, and the connecting part is connected to the driving member. After this structure is used, a structure of the transmission assembly is simple, providing a good driving effect. The partition divides the inner cavity of the base into the first cavity and the second cavity, the teeth plate is accommodated in the first cavity, and the driving member is accommodated in the second cavity, so that the teeth plate and the driving member do not affect each other, and a structure is reliable.

As an improvement, the transmission assembly further includes a plurality of second driving gears, the plurality of second driving gears are accommodated in the first cavity, the plurality of second driving gears are rotatably connected to the partition, and a side of each of the plurality of second driving gears meshes with the gear part of the first driving gear; and a protruding edge is disposed on an edge of a side that is of the teeth plate and that is close to the second driving gear, a gear ring is disposed on an inner wall of the protruding edge, the teeth plate covers outside the plurality of second driving gears, and the other end of the each of the plurality of second driving gears meshes with the gear ring. After this structure is used, the gear ring and the gear part of the first driving gear are driven by the second driving gear, so that a structure is simple, and assembly is easy to perform.

As an improvement, a middle of the teeth plate is provided with a second pencil inserting hole, a middle of the first driving gear is provided with a shaft hole, and the shaft hole is aligned with the second pencil inserting hole; and an elastic buckle is disposed on a side that is of the teeth plate and that is close to the first driving gear, a limiting step is disposed in the shaft hole, the elastic buckle is inserted into the shaft hole, the elastic buckle is buckled on the limiting step, and the teeth plate and the first driving gear can rotate relative to each other. After this structure is used, the teeth plate and the first driving gear are assembled by using the elastic buckle and the limiting step, so that a structure is more stable and reliable.

As an improvement, the driving member has a cover-shaped structure, a middle of the driving member is provided with a third pencil inserting hole, the third pencil inserting hole is aligned with the second pencil inserting hole; a protruding ring is disposed on a side that is of the middle of the driving member and that is close to the connecting part, and the protruding ring is embedded in the shaft hole of the first driving gear; and connecting teeth configured to be connected to the driving source are disposed on an inner wall of the protruding ring. After this structure is used, the structure is simple, and assembly is easy to perform.

As an improvement, a plurality of elastic sheets are disposed on an outer peripheral wall of the connecting part of the first driving gear, the plurality of elastic sheets are accommodated between the protruding ring and a side wall of the driving member; and a protrusion is disposed at an end of each of the plurality of elastic sheets, an inner side of the side wall of the driving member is provided with a second groove that matches the protrusion, and the protrusion is embedded in the second groove. After this structure is used, a structure between the first driving gear and the driving member is simple and is easy to assemble, providing a good connection effect.

Another technical problem to be provided in this disclosure is as follows: a pencil sharpener is provided, where a pencil feeding mechanism provided for the pencil sharpener is used in pencils with different shapes and different diameters, so that the pencil feeding mechanism is universally used.

The technical solution in this disclosure is as follows: a pencil sharpener provided with the following structure is provided, including a casing, the pencil feeding mechanism and the pencil sharpening mechanism with the foregoing structures are disposed in the casing, the pencil feeding mechanism is disposed on an upper side of the pencil sharpener, and the pencil feeding mechanism is connected to the pencil sharpening mechanism.

After the foregoing structure is used, compared with existing technologies, the pencil sharpener in this disclosure has the following advantages:

Because one end of the pencil clamping roller assembly of the pencil feeding mechanism of the pencil sharpener in this disclosure is rotatably connected to the support, the other end of the pencil clamping roller assembly is slidably connected to the support. When pencils with different shapes and different sizes are inserted into the triangular pencil clamping region, a position of the other end of the pencil clamping roller assembly is adjusted. The clamping assembly is disposed between the movable end of the pencil clamping roller assembly and the support. The clamping piece is movably connected to the support, the clamping piece abuts against the movable end of the pencil clamping roller assembly, and the return elastic piece is supported between the each clamping piece and the support. When the other end of the pencil clamping roller assembly moves outward, the each clamping piece provides an elastic thrust to the other end of the pencil clamping roller assembly, so that the pencil clamping roller assembly always contacts the pencil.

### BRIEF DESCRIPTION OF THE DRAWINGS

FIG. 1 is a schematic three-dimensional structural diagram of a pencil feeding mechanism according to this disclosure;

FIG. 2 is a schematic exploded structural diagram of a pencil clamping apparatus of a pencil feeding mechanism according to this disclosure;

FIG. 3 is a partially schematic exploded structural diagram of a pencil clamping apparatus of a pencil feeding mechanism according to this disclosure;

FIG. 4 is a schematic structural assembly diagram of a pencil clamping roller assembly and a support of a pencil feeding mechanism according to this disclosure;

FIG. 5 is a schematic structural assembly diagram of a pencil clamping roller assembly and a support of a pencil feeding mechanism from another angle according to this disclosure;

FIG. 6 is a schematic exploded structural diagram of a pencil clamping roller assembly and a support of a pencil feeding mechanism according to this disclosure;

FIG. 7 is a schematic exploded structural diagram of a pencil clamping roller assembly of a pencil feeding mechanism according to this disclosure;

FIG. 8 is a schematic three-dimensional structural diagram of a driving apparatus of a pencil feeding mechanism according to this disclosure;

FIG. 9 is a schematic three-dimensional structural diagram of a driving apparatus of a pencil feeding mechanism from another angle according to this disclosure;

FIG. 10 is a partially schematic exploded structural diagram of a driving apparatus of a pencil feeding mechanism according to this disclosure;

FIG. 11 is a schematic three-dimensional structural diagram of a first driving gear of a pencil feeding mechanism according to this disclosure;

FIG. 12 is a schematic exploded structural diagram of a driving apparatus of a pencil feeding mechanism according to this disclosure; and

FIG. 13 is a partially schematic structural assembly diagram of a driving apparatus of a pencil feeding mechanism according to this disclosure.

The following are shown in the figures: 1, support; 101, first support wall; 102, second support wall; 103, third support wall; 104, embedding groove; 105, first groove; 106, sliding groove; 107, limiting ring; 108, accommodating cavity; 2, upper cover; 201, first pencil inserting hole; 202, matching hole; 203, bolt-shaped column; 204, positioning column; 3, synchronizing piece; 301, fourth pencil inserting hole; 302, sliding rail; 303, inserting hole; 304, rotating rail hole; 4, triangular pencil clamping region; 5, rotating shaft; 501, limiting plane; 502, ball head; 503, protruding column; 6, roller; 7, gear; 701, shaft sleeve; 8, limiting sheet; 9, connecting sleeve; 901, embedding ring; 10, clamping piece; 1001, arc-shaped surface; 11, elastic hoop; 1101, inserting pin; 1102, ferrule; 12, base; 1201, partition; 1202, first cavity; 1203, second cavity; 1204, connecting hole; 13, driving member; 1301, protruding ring; 1302, connecting teeth; 1303, second groove; 14, teeth plate; 1401, protruding edge; 1402, gear ring; 1403, second pencil inserting hole; 1404, elastic buckle; 1405, stirring teeth; 15, first driving gear; 1501, gear part; 1502, limiting step; 1503, connecting part; 1504, elastic sheet; 16, second driving gear.

### DETAILED DESCRIPTION OF THE EMBODIMENTS

To better understand this disclosure, various aspects of this disclosure are described in more detail with reference to accompanying drawings. It should be understood that these detailed descriptions are merely descriptions of example implementations of this disclosure and are not intended to limit the scope of this disclosure in any way. Throughout this specification, same reference numerals mean same elements.

In the drawings, thicknesses, sizes, and shapes of objects have been slightly expanded for illustration. The drawings are examples only and are not formulated strictly to scale.

It should be further understood that the terms “comprise,” “include,” “have,” “comprising,” and “including” when used in this specification indicate existence of features, integers, steps, operations, elements and/or components. However, this does not exclude existence or addition of one or more other features, integers, steps, operations, elements, parts, and/or combinations thereof.

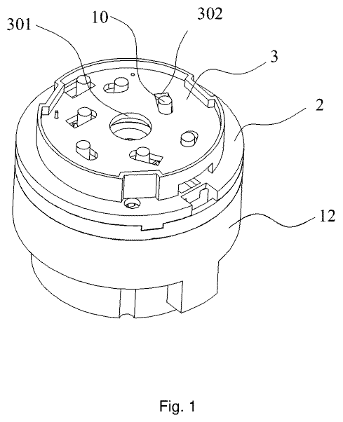

As shown in FIG. 1, this disclosure discloses a pencil feeding mechanism, including a driving apparatus and a pencil clamping apparatus. The driving apparatus is connected to the pencil clamping apparatus, and the driving apparatus can drive the pencil clamping apparatus to work.

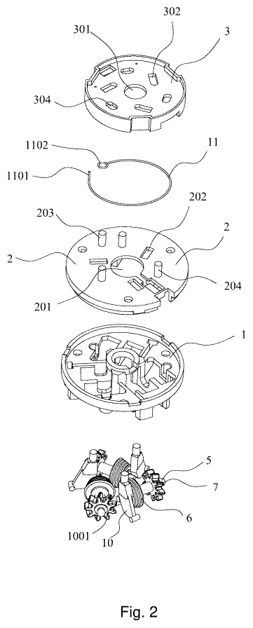

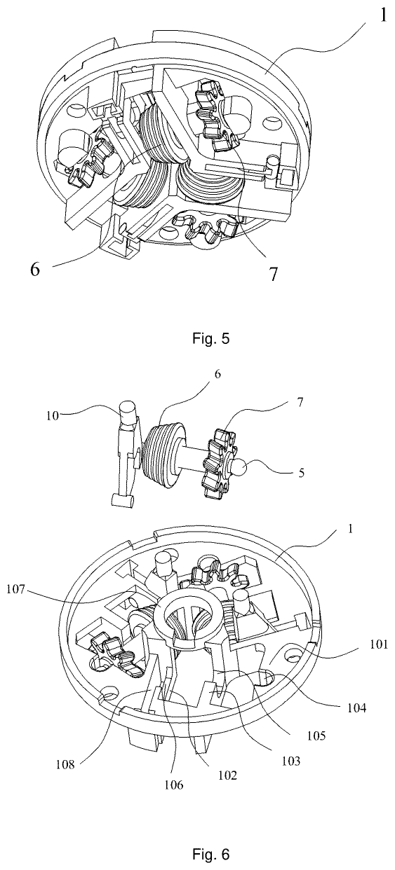

As shown in FIG. 2 to FIG. 7, the pencil clamping apparatus includes a support 1, an upper cover 2, and a synchronizing piece 3. Three pencil clamping roller assemblies are disposed on the support 1, structures and installation structures of the three pencil clamping roller assemblies are both the same, and a triangular pencil clamping region 4 capable of being inserted by a pencil is formed among the three pencil clamping roller assemblies.

One end of each of the pencil clamping roller assemblies is rotatably connected to the support 1, and the other end of the each of the pencil clamping roller assemblies is slidably connected to the support 1. A clamping assembly is disposed between movable ends of the pencil clamping roller assemblies and the support 1. The clamping assembly includes clamping pieces 10 and a return elastic piece. Each clamping piece 10 is movably connected to the support 1, and the each clamping piece 10 abuts against the movable end of a corresponding pencil clamping roller assembly, and the return elastic piece is supported between the each clamping piece 10 and the support 1. After the foregoing structure is used, the pencil feeding mechanism in this disclosure has the following advantages:

Because one end of the each pencil clamping roller assembly of the pencil feeding mechanism in this disclosure is rotatably connected to the support, the other end of the each pencil clamping roller assembly is slidably connected to the support 1. When pencils with different shapes and different sizes are inserted into the triangular pencil clamping region, a position of the other end of the each pencil clamping roller assembly is adjusted. The clamping assembly is disposed between the movable end of the pencil clamping roller assembly and the support 1. The clamping piece is movably connected to the support 1, and the clamping piece 10 abuts against the movable end of the corresponding pencil clamping roller assembly, and the return elastic piece is supported between the each clamping piece 10 and the support 1. When the other end of the pencil clamping roller assembly is moved outward, the clamping piece 10 provides an elastic thrust to the other end of the pencil clamping roller assembly, so that the pencil clamping roller assembly always contacts the pencil.

In an embodiment, the return elastic piece includes an elastic hoop 11, and the elastic hoop 11 is sleeved outside the other ends of three clamping pieces 10. The support 1 is rotatably connected to a synchronizing piece 3. One end of the elastic hoop 11 is connected to the support 1, and the other end of the elastic hoop 11 is connected to the synchronizing piece 3. When the elastic hoop 11 is squeezed by the each clamping piece 10 to be twisted, the synchronizing piece 3 is driven to rotate.

After this structure is used, the elastic hoop 11 hoops outside the other ends of the clamping pieces 10, so that the clamping pieces 10 move synchronously, and the pencil clamping roller assembly does not move eccentrically.

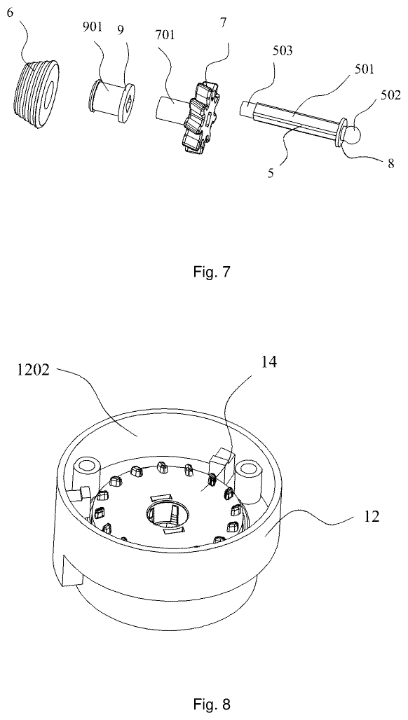

In an embodiment, as shown in FIG. 2, FIG. 4, and FIG. 7, the each pencil clamping roller assembly includes a rotating shaft 5, a roller 6, and a gear 7. A side wall of the rotating shaft 5 is provided with at least one limiting plane 501. In this specific embodiment, a cross section of the rotating shaft 5 is square. An end of the rotating shaft 5 is provided with a limiting sheet 8, and the limiting sheet 8 is round. A side of the gear 7 is connected to a shaft sleeve 701, and the shaft sleeve 701 and the gear 7 are integrally formed. A middle of the gear 7 is provided with a shaft hole, and the shaft hole and a through hole of the shaft sleeve 701 are coaxial and communicate. A shape of the shaft hole and a shape of the through hole of the shaft sleeve 701 are matched with a shape of the rotating shaft 5. The gear 7 and the shaft sleeve 701 are sleeved outside the rotating shaft 5, and an end surface of the gear 7 abuts against the limiting sheet 8. A middle of the roller 6 is provided with an installation hole, and a connecting sleeve 9 is disposed in the installation hole. An embedding ring 901 is disposed on an outer peripheral wall of the connecting sleeve 9. The roller 6 is made of a rubber material, and an inner ring of the roller 6 is embedded in the embedding ring 901. A shape of a through hole of the connecting sleeve 9 matches the shape of the rotating shaft 5, the connecting sleeve 9 is sleeved outside the rotating shaft 5, the connecting sleeve 9 tightly cooperates with the rotating shaft 5, and an end of the connecting sleeve 9 abuts against an end surface of the shaft sleeve 701.

In an embodiment, a side of the middle of the each clamping piece 10 is an arc-shaped surface 1001, and the arc-shaped surface 1001 abuts against the other end of the rotating shaft 5. After this structure is used, the arc-shaped surface 1001 of the clamping piece 10 contacts the other end of the rotating shaft 5, and a clamping force of the clamping piece 10 can be effectively controlled by setting a radian of the arc-shaped surface 1001, so that a clamping effect is good.

In an embodiment, as shown in FIG. 6 and FIG. 7, a first support wall 101, a second support wall 102, and a third support wall 103 are disposed on the support 1. A ball head 502 is disposed at an end that is of the rotating shaft 5 and that is close to the gear 7, and the ball head 502 is disposed on an outer side of the limiting sheet 8. A side wall of the first support wall 101 is provided with an embedding groove 104 that matches the ball head 502, and the ball head 502 is rotatably connected in the embedding groove 104. The third support wall 103 is disposed on a lower side of the shaft sleeve 701 on the rotating shaft 5, an upper end surface of the third support wall 103 is provided with a first groove 105, and the shaft sleeve 701 is embedded in the first groove 105. The second support wall 102 is provided with a sliding groove 106, and an end that is of the rotating shaft 5 and that is close to the roller 6 is provided with a protruding column 503. A cross section of the protruding column 503 is circular, and the protruding column 503 is installed at a groove bottom of the sliding groove 106 in a rolling manner, and the rotating shaft 5 is applied a force, so that the protruding column 503 can slide back and forth along the groove bottom of the sliding groove 106. The each pencil clamping roller assembly on the support 1 is installed by using the first support wall 101, the second support wall 102, and the third support wall 103, and installation structures are all the same.

In an embodiment, a limiting ring 107 configured to insert a pencil is disposed in the middle of the support 1. The limiting ring 107 is connected to all the second support wall 102 and the third support wall 103 on the support 1. The limiting ring 107 is erected right above the triangular pencil clamping region 4, and an orthographic projection of the limiting ring 107 covers a part of the roller 6. A pencil can be positioned by using the limiting ring 107, so that the pencil is sharpened more stably.

In an embodiment, a clamping assembly is disposed at a position on the support 1 and close to the protruding column 503, and the clamping assembly includes the clamping pieces 10 and the return elastic piece. An accommodating cavity 108 is disposed on the second support wall 102, and an upper end and a lower end of the accommodating cavity 108 are both open. The accommodating cavity 108 communicates with the sliding groove 106, and an end of the protruding column 503 extends into the accommodating cavity 108. A lower end of the each clamping piece 10 is hinged on a side wall of the accommodating cavity 108, and a side of a middle of the clamping piece 10 abuts against a corresponding protruding column 503. In an embodiment, a side that is of the middle of the clamping piece 10 and that is close to the corresponding protruding column 503 is provided with an arc-shaped surface 1001. The arc-shaped surface 1001 abuts against an outer wall of the protruding column 503. A protruding ring 1301 slides outward, so that the each clamping piece 10 can be pushed to rotate around a joint of the lower end of the each clamping piece 10.

In an embodiment, the upper cover 2 is connected to an upper side of the support 1, and the upper cover 2 covers the pencil clamping roller assemblies. A middle of the upper cover 2 is provided with a first pencil inserting hole 201. The first pencil inserting hole 201 is located right above the triangular pencil clamping region 4, and an orthographic projection of the first pencil inserting hole 201 covers a part of a roller 6 of the pencil clamping roller assemblies. The upper cover 2 is provided with a matching hole 202, in an embodiment, the matching holes 202 correspond to the clamping pieces 10, an upper end of the each clamping piece 10 penetrates the corresponding matching hole 202 and is exposed outside the upper cover 2, and the each clamping piece 10 can move in the corresponding matching hole 202. The return elastic piece is the elastic hoop 11, and the elastic hoop 11 hoops outside the upper ends of the clamping pieces 10.

After this structure is used, the upper cover 2 is disposed to protect an internal structure, so that the structure is more reliable.

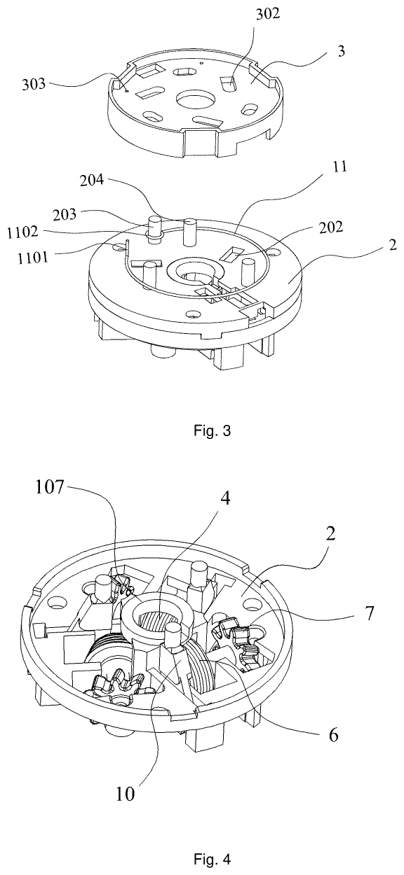

In an embodiment, as shown in FIG. 2 and FIG. 3, a synchronizing piece 3 is disposed on the upper cover 2, a middle of the synchronizing piece 3 is provided with a fourth pencil inserting hole 301, and the fourth pencil inserting hole 301 is aligned with the first pencil inserting hole 201. A sliding rail 302 is disposed on the synchronizing piece 3. One end of the clamping piece 10 is hinged on the support, and the other end of the clamping piece 10 extends into the sliding rail 302. The clamping piece 10 slidably cooperates with the corresponding sliding rail 302. The synchronizing piece 3 rotates, to drive the clamping piece 10 to rotate, and the upper end of the clamping piece 10 slides along the sliding rail 302. After this structure is used, when pencils with different shapes and sizes are inserted into the triangular pencil clamping region, a movable end of the pencil clamping roller assembly is squeezed to move, thus pushing the clamping piece 10 to rotate. The elastic hoop 11 is twisted when applied with a force, to drive the synchronizing piece 3 to rotate. The synchronizing piece 3 rotates, to drive the upper end of the clamping piece 10 to slide along the corresponding sliding rail 302, so that the upper end of the clamping piece 10 makes opening and closing actions with the lower end as a center of a circle. Therefore, a pencil is always in the middle of the three pencil clamping roller assemblies when sharpened, and sharpening is more stable and not eccentric.

In a specific embodiment, the sliding rail 302 has a hole-shaped structure. The elastic hoop 11 is disposed in space between the synchronizing piece 3 and the upper cover 2. One end of the elastic hoop 11 is connected to the synchronizing piece 3, that is, the synchronizing piece 3 is provided with an inserting hole 303. The end of the elastic hoop 11 is folded upward to form an inserting pin 1101, and the inserting pin 1101 is inserted into the inserting hole 303. The other end of the elastic hoop 11 is connected to the upper cover 2, that is, the upper cover 2 is provided with a bolt-shaped column 203, and the other end of the elastic hoop 11 is provided with a ferrule 1102, and the ferrule 1102 is sleeved outside the bolt-shaped column 203. After this structure is used, the pencil is well positioned, and the elastic hoop 11 and the synchronizing piece 3 are easily assembled. An assembly structure between the upper cover 2 and the elastic hoop 11 is simple, and assembly is easily performed.

In an embodiment, a sliding direction of the sliding rail 302 intersects with a swinging direction of the corresponding clamping piece 10. After this structure is used, when the synchronizing piece 3 is rotated, rotation of the clamping piece 10 is not affected, providing a good cooperation effect.

Multiple positioning columns 204 are disposed on a side that is of the upper cover 2 and that is close to the synchronizing piece 3. The synchronizing piece 3 is provided with rotating rail holes 304 that match the positioning columns 204, and ends of the positioning columns 204 are fitted in the rotating rail holes 304. When the synchronizing piece 3 is driven by the elastic hoop 11 to rotate, the positioning column 204 slides relative to the corresponding rotating rail hole 304. The each positioning column 204 is located inside the elastic hoop 11. After this structure is used, the positioning column 204 can define a moving track of the synchronizing piece 3, so that the synchronizing piece 3 can accurately drive the clamping pieces 10, an effect of synchronous rotation of the clamping pieces 10 is achieved.

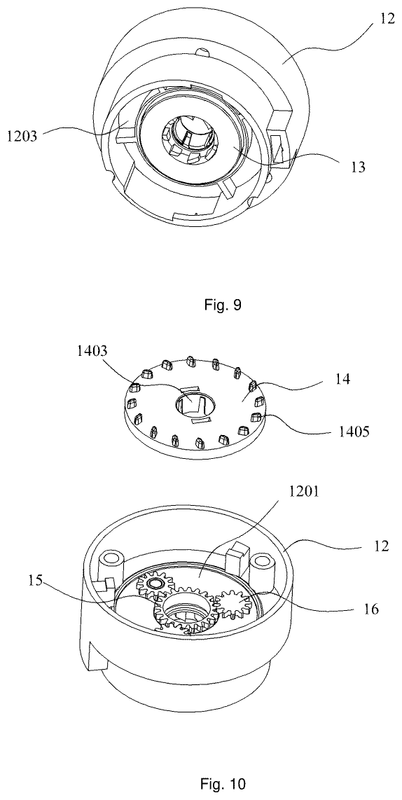

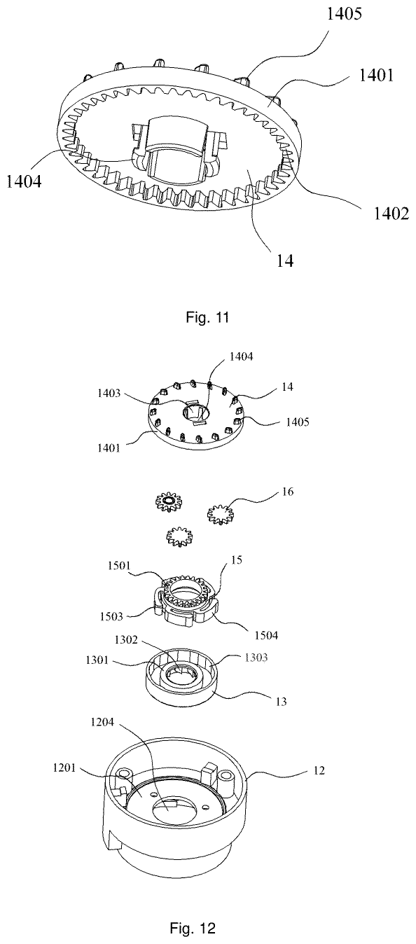

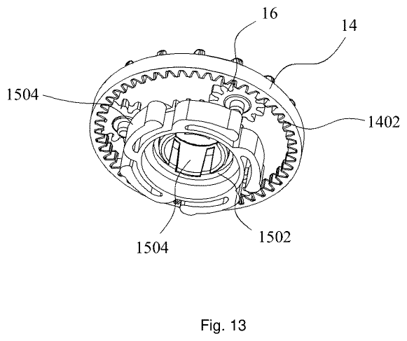

As shown in FIG. 8 to FIG. 13, in an embodiment of this disclosure, the driving apparatus includes a base 12, and a driving member 13, a transmission assembly, and a teeth plate 14 are disposed in the base 12. An upper end and a lower end of the base 12 are provided with openings, and a middle of the base 12 is provided with a partition 1201. The partition 1201 divides an inner cavity of the base 12 into a first cavity 1202 and a second cavity 1203, and a middle of the partition 1201 is provided with a connecting hole 1204. The transmission assembly includes a first driving gear 15, and a middle of the first driving gear 15 is rotatably connected in the connecting hole 1204.

In an embodiment, a gear part 1501 is disposed at an end of the first driving gear 15, and the gear part 1501 extends into the first cavity 1202. The teeth plate 14 is accommodated in the first cavity 1202, and the gear part 1501 is in transmission connection with the teeth plate 14. The transmission assembly further includes multiple second driving gears 16. In this embodiment, there are three second driving gears 16, the second driving gears 16 are accommodated in the first cavity 1202, and the second driving gears 16 are rotatably connected to the partition 1201, that is, connecting shafts are disposed in middles of the second driving gears 16. The partition 1201 is provided with shaft through holes, and the connecting shaft is rotatably inserted into a corresponding shaft through hole. A side of each second driving gear 16 meshes with the gear part 1501 of the first driving gear 15. A protruding edge 1401 is disposed on an edge of a side that is of the teeth plate 14 and that is close to the second driving gears 16, and a gear ring 1402 is disposed on an inner wall of the protruding edge 1401. The teeth plate 14 covers outside the second driving gears 16, and the other end of the each second driving gear 16 meshes with the gear ring 1402.

A middle of the teeth plate 14 is provided with a second pencil inserting hole 1403, and a middle of the first driving gear 15 is provided with a shaft hole. The shaft hole is aligned with the second pencil inserting hole 1403. An elastic buckle 1404 is disposed on a side that is of the teeth plate 14 and that is close to the first driving gear 15, and a limiting step 1502 is disposed in the shaft hole. The elastic buckle 1404 is inserted into the shaft hole, and the elastic buckle 1404 is buckled on the limiting step 1502. The teeth plate 14 and the first driving gear 15 can rotate relative to each other. The support 1 of the pencil clamping apparatus is connected to an upper end of the base 12, and the teeth plate 14 is located below the each pencil clamping roller assembly. Multiple stirring teeth 1405 are disposed at an edge of an end surface that is of the teeth plate 14 and that is close to the pencil clamping roller assembly, and the gear 7 meshes with one of the stirring teeth 1405. When the teeth plate 14 rotates, the gear 7 is sequentially stirred by different stirring teeth 1405 to rotate.

In an embodiment, a connecting part 1503 is disposed at the other end of the first driving gear 15, and the connecting part 1503 is inserted into the second cavity 1203. The driving member 13 is accommodated in the second cavity 1203, and the connecting part 1503 is connected to the driving part. The driving member 13 has a cover-shaped structure. A middle of the driving member 13 is provided with a third pencil inserting hole, and the third pencil inserting hole is aligned with the second pencil inserting hole 1403. A protruding ring 1301 is disposed on a side that is of a middle of the driving member 13 and that is close to the connecting part 1503, and the protruding ring 1301 is embedded in the shaft hole of the first driving gear 15. Connecting teeth 1302 configured to be connected to a driving source are disposed on an inner wall of the protruding ring 1301.

In an embodiment, a plurality of elastic sheets 1504 are disposed on an outer peripheral wall of the connecting part 1503 of the first driving gear 15, and the elastic sheets 1504 are accommodated between the protruding ring 1301 and a side wall of the driving member 13. A protrusion is disposed at an end of each elastic sheet 1504, and an inner side of the side wall of the driving member 13 is provided with a second groove 1303 that matches the protrusion. The protrusion is embedded in the second groove 1303. After this structure is used, a structure between the first driving gear 15 and the driving member 13 is simple, and assembly is easy to perform, providing a good connection effect. When the pencil feeding mechanism disclosed in this disclosure works, the driving source drives the driving member 13 to rotate, to drive the first driving gear 15 to rotate; and with the rotation of the first driving gear 15, the second driving gear 16 is driven to rotate, thereby driving the teeth plate 14 to rotate. When the teeth plate 14 rotates, the stirring teeth 1405 on the teeth plate 14 can stir the gear 7 to rotate, thereby driving the rotating shaft 5 and the roller 6 to rotate. The driving source is able to drive the driving member 13 to rotate forward or backward, to drive all three rollers 6 to rotate inward or outward. When all three rollers 6 rotate inward, a pencil can be wound into the pencil feeding mechanism, while when all three rollers 6 rotate outward, the pencil can be removed from the pencil feeding mechanism.

Pencils with different pencil diameters or shapes sequentially pass through a fourth pencil inserting hole 301 and the first pencil inserting hole 201, and then enter the triangular pencil clamping region 4. The rotating shaft 5 is squeezed by a pencil, and the protruding column 503 at an end of the rotating shaft 5 slides in the sliding groove 106. With sliding of the protruding column 503, the corresponding clamping piece 10 is pushed to rotate, and rotation of the clamping piece 10 enables the elastic hoop 11 to twist, thereby driving the synchronizing piece 3 to rotate. With the rotation of the synchronizing piece 3, the clamping piece 10 can be driven to rotate synchronously, so that the clamping pieces 10 are synchronously opened, and the roller 6 is adjusted to a proper position. The pencil is driven by the roller 6 to be rolled into the pencil feeding mechanism. When the pencil is removed from the pencil feeding mechanism, the pencil no longer squeezes the roller 6, and the protruding column 503 returns to an initial position under a clamping force of the clamping piece 10. In this case, the synchronizing piece 3 can drive the clamping pieces 10 to close synchronously.

This disclosure further discloses a pencil sharpener, including a casing. The pencil feeding mechanism and the pencil sharpening mechanism with the foregoing structures are disposed in the casing, and the pencil feeding mechanism is disposed on an upper side of the pencil sharpening mechanism. The pencil sharpener includes a hob and a hob support, and the hob is in transmission connection with connecting teeth of a driving member of the pencil feeding mechanism.

This disclosure is not limited to the foregoing best implementation. Anyone can derive various other forms of products under the inspiration of this disclosure. However, regardless of any changes in shapes or structures of the products, technical solutions similar to technical solutions in this disclosure shall fall within the protection scope of this disclosure.

1. A pencil feeding mechanism, comprising a driving apparatus and a pencil clamping apparatus, wherein the driving apparatus is connected to the pencil clamping apparatus, and the driving apparatus is capable of driving the pencil clamping apparatus to work; the pencil clamping apparatus comprises a support, three pencil clamping roller assemblies are disposed on the support, and a triangular pencil clamping region capable of being inserted by a pencil is formed among the three pencil clamping roller assemblies, wherein one end of each of the pencil clamping roller assemblies is rotatably connected to the support, and an other end of the each of the pencil clamping roller assemblies is slidably connected to the support; and a clamping assembly is disposed between movable ends of the pencil clamping roller assemblies and the support, the clamping assembly comprises clamping pieces and a return elastic piece, the clamping pieces are movably connected to the support, each of the clamping pieces abuts against a movable end of a corresponding pencil clamping roller assembly in the three pencil clamping roller assemblies, and the return elastic piece is supported between the clamping pieces and the support.

2. The pencil feeding mechanism according to claim 1, wherein the return elastic piece comprises an elastic hoop, and the elastic hoop is sleeved outside an other ends of three clamping pieces; the support is rotatably connected to a synchronizing piece; one end of the elastic hoop is connected to the support, and an other end of the elastic hoop is connected to the synchronizing piece; and when the elastic hoop is squeezed by the each of the clamping pieces to be twisted, the synchronizing piece is driven to rotate.

3. The pencil feeding mechanism according to claim 2, wherein the synchronizing piece is disposed on an upper side of the each of the clamping pieces, and sliding rails are disposed at positions at which the synchronizing pieces corresponding to the clamping pieces; a lower end of the each of the clamping pieces is hinged on the support, and an upper end of the each of the clamping pieces is slidably fitted in a corresponding sliding rail in the sliding rails; and the synchronizing piece rotates, to drive the each of the clamping pieces to rotate, and the upper end of the each of the clamping piece slides along the corresponding sliding rail.

4. The pencil feeding mechanism according to claim 3, wherein a sliding direction of each of the sliding rails intersects with a swinging direction of the each of the clamping pieces; or, the support comprises an upper cover, and the upper cover is connected on a side that is of the support and that is close to the synchronizing piece; the synchronizing piece is rotatably connected to an upper side of the upper cover; and the elastic hoop is disposed between the upper cover and the synchronizing piece, and an end of the elastic hoop is connected to the upper cover.

5. (canceled)

6. The pencil feeding mechanism according to claim 4, wherein the support comprises an upper cover, a first pencil inserting hole is disposed in the upper cover and above the triangular pencil clamping region, and an orthographic projection of the first pencil inserting hole covers a part of a roller of each pencil clamping roller assembly; and the upper cover is provided with matching holes, the matching holes correspond to the clamping pieces, and the other end of the each of the clamping pieces penetrates a corresponding matching hole in the matching holes and is fitted in the corresponding sliding rail.

7. The pencil feeding mechanism according to claim 6, wherein a plurality of positioning columns are disposed on a side that is of the upper cover and that is close to the synchronizing piece; the synchronizing piece is provided with rotating rail holes that match the plurality of positioning columns, and ends of the plurality of positioning columns are fitted in the rotating rail holes; and when the synchronizing piece is driven by the elastic hoop to rotate, the positioning columns and the rotating rail holes slide relative to each other.

8. The pencil feeding mechanism according to claim 7, wherein a middle of the synchronizing piece is provided with a fourth pencil inserting hole, and the fourth pencil inserting hole is aligned with the first pencil inserting hole; and the synchronizing piece is provided with an inserting hole, an end of the elastic hoop is folded upward to form an inserting pin, and the inserting pin is inserted into the inserting hole; or, a bolt-shaped column is disposed on a side that is of the upper cover and that is close to the synchronizing piece, an end of the elastic hoop is provided with a ferrule, and the ferrule is sleeved outside the bolt-shaped column.

9. (canceled)

10. The pencil feeding mechanism according to claim 4, wherein a first support wall and a second support wall are disposed on the support, and the pencil clamping roller assemblies are disposed between the first support wall and the second support wall; the each of the pencil clamping roller assemblies comprises a rotating shaft, and an end of the rotating shaft is rotatably connected to the first support wall; and the second support wall is provided with a sliding groove, and an other end of the rotating shaft is slidably fitted in the sliding groove

11. The pencil feeding mechanism according to claim 10, wherein the second support wall is provided with an accommodating cavity, and the accommodating cavity communicates with the sliding groove; and a corresponding clamping piece in the clamping pieces is movably installed in the accommodating cavity, a side of the corresponding clamping piece abuts against a movable end of the rotating shaft, and when an other end of the rotating shaft slides, the corresponding clamping piece can be pushed to move outward.

12. The pencil feeding mechanism according to claim 11, wherein an end of the corresponding clamping piece is hinged on a side wall of the accommodating cavity, a side of a middle of the corresponding clamping piece abuts against the other end of the rotating shaft, and the other end of the corresponding clamping piece is connected to the return elastic piece; preferably, the side of the middle of the each of the clamping pieces is an arc-shaped surface, and the arc-shaped surface abuts against the other end of the rotating shaft.

13. (canceled)

14. The pencil feeding mechanism according to claim 10, wherein the each of the pencil clamping roller assemblies comprises a roller, wherein the roller is installed on the rotating shaft, and a gear is also installed on the rotating shaft; and the gear is connected to the driving apparatus, the driving apparatus is able to drive the gear to rotate, and the gear is capable of driving the rotating shaft and the roller to rotate synchronously.

15. The pencil feeding mechanism according to claim 14, wherein a third support wall is disposed on the support and between the first support wall and the second support wall, and the third support wall is supported on a lower side of a part that is of the rotating shaft and that is between the gear and the roller.

16. The pencil feeding mechanism according to claim 15, wherein an upper surface of the third support wall is provided with a first groove, and the rotating shaft is embedded in the first groove; or, a limiting ring configured to be inserted by a pencil is disposed in a middle of the support, and the limiting ring is connected to the second support wall and the third support wall, the limiting ring is erected right above the triangular pencil clamping region, and an orthographic projection of the limiting ring covers a part of the roller.

17. The pencil feeding mechanism according to claim 16, wherein when an upper surface of the third support wall is provided with the first groove, a side of the gear is connected to a shaft sleeve, a middle of the gear is provided with a shaft hole, and the shaft hole and a through hole of the shaft sleeve are coaxial and communicate; at least one limiting plane is disposed on a side wall of the rotating shaft and a shape of the shaft hole of the gear and a shape of the through hole of the shaft sleeve match a cross section of the rotating shaft; the gear and the shaft sleeve are sleeved outside the rotating shaft, and an end of the shaft sleeve abuts against the roller; and the shaft sleeve is embedded in the first groove.

18. The pencil feeding mechanism according to claim 17, wherein a middle of the roller is provided with an installation hole, and a connecting sleeve is disposed in the installation hole; a shape of a through hole of the connecting sleeve matches a shape of the cross section of the rotating shaft, the connecting sleeve is tightly fitted outside the rotating shaft, and the connecting sleeve abuts against an outer side of the shaft sleeve; or, a limiting sheet is disposed on the rotating shaft and on an outer side of the gear, and the limiting sheet is able to perform limitation on the outer side of the gear.

19. (canceled)

20. The pencil feeding mechanism according to claim 18, wherein a ball head is disposed at an end that is of the rotating shaft and that is close to the gear, a side wall of the first support wall is provided with an embedding groove that matches the ball head, and the ball head is rotatably connected in the embedding groove; preferably, a protruding column is disposed at an end that is of the rotating shaft and that is close to the roller, a cross section of the protruding column is circular, and the protruding column is installed at a groove bottom of the sliding groove in a rolling manner.

21-22. (canceled)

23. The pencil feeding mechanism according to claim 14, wherein the driving apparatus comprises a base, and a driving member, a transmission assembly, and a teeth plate are disposed in the base; the driving member is configured to be connected to a driving source, the transmission assembly is connected between the driving member and the teeth plate, and multiple stirring teeth are disposed on the teeth plate; and the driving member is capable of driving, by using the transmission assembly, the teeth plate to rotate, and when the teeth plate rotates, the multiple stirring teeth can stir the gear of the each pencil clamping roller assembly to rotate, thereby driving the roller of the each pencil clamping roller assembly to rotate; preferably, a middle of the base is provided with a partition, the partition divides an inner cavity of the base into a first cavity and a second cavity, and a middle of the partition is provided with a connecting hole; the transmission assembly comprises a first driving gear, and a middle of the first driving gear is rotatably connected in the connecting hole, a gear part is disposed at an end of the first driving gear, and the gear part extends into the first cavity, the teeth plate is accommodated in the first cavity, and the gear part is in transmission connection with the teeth plate; and a connecting part is disposed at an other end of the first driving gear, and the connecting part extends into the second cavity, the driving member is accommodated in the second cavity, and the connecting part is connected to the driving member.

24. (canceled)

25. The pencil feeding mechanism according to claim 23, wherein the transmission assembly further comprises a plurality of second driving gears, the plurality of second driving gears are accommodated in the first cavity, the plurality of second driving gears are rotatably connected to the partition, and a side of each of the plurality of second driving gears meshes with the gear part of the first driving gear; a protruding edge is disposed on an edge of a side that is of the teeth plate and that is close to the second driving gear, a gear ring is disposed on an inner wall of the protruding edge, the teeth plate covers outside the plurality of second driving gears, and an other end of the each of the plurality of second driving gears meshes with the gear ring; wherein a middle of the teeth plate is provided with a second pencil inserting hole, the middle of the first driving gear is provided with a shaft hole, and the shaft hole is aligned with the second pencil inserting hole; and an elastic buckle is disposed on a side that is of the teeth plate and that is close to the first driving gear, a limiting step is disposed in the shaft hole, the elastic buckle is inserted into the shaft hole, the elastic buckle is buckled on the limiting step, and the teeth plate and the first driving gear are capable of rotating relative to each other.

26. (canceled)

27. The pencil feeding mechanism according to claim 25, wherein the driving member has a cover-shaped structure, a middle of the driving member is provided with a third pencil inserting hole, and the third pencil inserting hole is aligned with the second pencil inserting hole; a protruding ring is disposed on a side that is of the middle of the driving member and that is close to the connecting part, and the protruding ring is embedded in the shaft hole of the first driving gear; and connecting teeth configured to be connected to the driving source are disposed on an inner wall of the protruding ring; preferably, a plurality of elastic sheets are disposed on a peripheral wall of the connecting part of the first driving gear, the plurality of elastic sheets are accommodated between the protruding ring and a side wall of the driving member, a protrusion is disposed at an end of each of the plurality of elastic sheets, an inner side of the side wall of the driving member is provided with a second groove that matches the protrusion, and the protrusion is embedded in the second groove.

28. (canceled)

29. A pencil sharpener, comprising a casing, wherein a pencil feeding mechanism and the pencil sharpening mechanism according to claim 1 are disposed in the casing, the pencil feeding mechanism is disposed on an upper side of the pencil sharpening mechanism, and the pencil feeding mechanism and the pencil sharpening mechanism are connected.
